(19) United States
(12) Patent Application Publication
(10) Pub. No.: US 2022/0157129 A1
(43) Pub. Date: May 19, 2022

(54) GAME SYSTEM AND BET MANAGEMENT DEVICE

(71) Applicant: Universal Entertainment Corporation, Tokyo (JP)

(72) Inventor: Shigehiko KITAGAWA, Tokyo (JP)

(21) Appl. No.: 17/431,814

(22) PCT Filed: Feb. 6, 2020
(86) PCT No.: PCT/JP2020/004454

§ 371 Date: Aug. 18, 2021

(30) Foreign Application Priority Data
Feb. 27, 2019 (JP) 2019-034749

(51) Int. Cl. G07F 17/32

(52) U.S. Cl. CPC G07F 17/3288; G07F 17/3237

(57) ABSTRACT

The present invention is to reduce the probability of occurrence of a mistake regarding the management work for a secret bet. A game system 1 is arranged to execute a game allowing selection of normal betting in which a bet is placed on the game and a content of the bet is public or secret betting in which the content of the bet is private until a game result of the game is determined, and includes a game management device 3 which includes a game management terminal 33 operated from outside and which executes the game and at least one bet management device 2 including a bet management terminal 21 operated from the outside and gaming value reader units 221 capable of reading, in a non-contact manner, gaming value information of a gaming medium used for the bet.

### TECHNICAL FIELD

The present invention relates to a game system and a bet management device which allow a player to place a bet on a game.

### BACKGROUND

Because the number of times of execution of a unit game is counted in a game such as baccarat in which steps from betting to payment of a payout are regarded as a unit game, a tournament (see, e.g., Patent Literature 1) may be held in which players repeatedly play a unit game and compete with one another based on an amount of payout. In this tournament, when a bet amount of one player is known to other players, the knowledge may disadvantageously influence on the rank of that player. Therefore, secret betting in which a bet amount is secret is usually adopted. Instead of placing a chip on a bet table, the secret betting is performed in such a way that a bet amount is written on a piece of paper and the piece of paper is handed to a dealer, the dealer carefully manages the piece of paper not to be seen by other players, and the piece of paper is disclosed to other players by the dealer after a game result is determined.

### CITATION LIST

### Patent Literatures

[PTL 1] International Publication No. 2013/019789

### SUMMARY OF THE INVENTION

### Technical Problem

However, in the known arrangement described above, because the management work for a secret bet requires disclosure of the content of a secret bet to other players after a game result is determined in addition to the management work for a normal bet by the dealer, a mistake regarding the management work for a secret bet is more likely to occur than a mistake regarding the management work for a normal bet.

The present invention has been made in view of the above. An object of the present invention is to provide a game system and a bet management device which reduce the probability of occurrence of a mistake regarding the management work for a secret bet.

### Solution to Problem

The present invention relates to a game system allowing selection of normal betting in which at least one bet is placed on a game and a content of the at least one bet is public or secret betting in which the content of the at least one bet is private until a game result of the game is determined, the game system comprising:

a game management device which includes a game management terminal operated from the outside and which executes the game; and

at least one bet management device which includes a bet management terminal operated from the outside and gaming value reader units capable of reading, in a non-contact manner, gaming value information of a gaming medium used for the at least one bet,

the at least one bet management terminal including:

an input device which enables an input from the outside;

a display device which shows an image to be visible from the display to the outside; and

a bet terminal controller programmed to execute: a process of displaying, on the display device, as the content of the at least one bet, the gaming value information of the gaming medium which is read by one of the gaming value reader units in which the normal betting is performed, in association with the one of the gaming value reader units;

a process of allowing the input device to specify one of the gaming value reader units in which the secret betting is performed;

a process of displaying secret-bet flag information on the display device, in association with the one of the gaming value reader units which is specified by the input device;

a process of sending bet-progress information indicating that the progress of the normal betting and the secret betting; and

a process of determining whether the game ends based on game result information from the game management terminal, and

the game management terminal including a gaming terminal controller programmed to execute:

a process of notifying the completion of preparation to start the game to the outside, in a case where it is determined based on the bet-progress information which is sent from the at least one bet management terminal that all bets including the normal betting and the secret betting are completed; and

a process of sending the game result information indicating an execution result of the game triggered by the completion of the preparation to start the game.

With this arrangement, because the existence of the secret betting is displayed as secret-bet flag information, the probability of occurrence of a mistake such as disclosure of the content of a secret bet (i.e., a bet of the secret betting) in the management work is reduced.

In the game system of the present invention, the bet terminal controller is programmed to further execute a process of displaying secret-bet warning information facilitating an input of the gaming value information of the secret betting on the display device when it is determined that the game ends.

With this arrangement, because the secret-bet warning information is displayed and the input of the gaming value information of the secret betting is facilitated, the probability of occurrence of a mistake regarding the input of the gaming value information is further reduced.

In the game system of the present invention, the bet terminal controller is programmed to further execute a process of prohibiting placement of at least one bet on the next execution of the game, until the input of the gaming value information of the secret betting is made for all of the gaming value reader units.

With this arrangement, an omission of the input of the gaming value information of the secret betting is prevented.

The present invention relates to a bet management device of a game system allowing selection of normal betting in which at least one bet is placed and a content of the at least one bet is public or secret betting in which the content of the at least one bet is private until a game result of the game is determined, the bet management device comprising:

a bet table including gaming value reader units capable of reading, in a non-contact manner, gaming value information of a gaming medium used for the at least one bet; and

a bet management terminal including an input device which enables an input form the outside, a display device which shows an image to be visible from the outside, and a bet terminal controller, the bet terminal controller is programmed to execute:

a process of displaying, on the display device, as the content of the at least one bet, the gaming value information of the gaming medium which is read by one of the gaming value reader units in which the normal betting is performed, in association with the one of the gaming value reader units;

a process of allowing the input device to specify one of the gaming value reader units in which the secret betting is performed; and

a process of displaying secret-bet flag information on the display device, in association with the one of the gaming value reader units which is specified by the input device.

With this arrangement, because the probability of occurrence of a mistake such as disclosure of the content of the secret bet in the management work is reduced in such a way that the existence of the secret betting is displayed as the secret-bet flag information, an additional bet management device is easily provided.

### Advantageous Effect of Invention

The present invention makes it possible to reduce the probability of occurrence of a mistake regarding the management work for a secret bet.

### BRIEF DESCRIPTION OF DRAWINGS

FIG. 1 is a block diagram of a game system.

FIG. 2 illustrates the overall structure of the game system.

FIG. 3 is a perspective view of a bet management device.

FIG. 4 is a block diagram of the bet management device.

FIG. 5 illustrates a state in which a bet is placed at the bet management device.

FIG. 6 is a block diagram of a gaming value reader unit.

FIG. 7 is a perspective view of the game management device.

FIG. 8 is a block diagram of the game management device.

FIG. 9 is a flowchart showing operation steps of the game system.

FIG. 10 is a flowchart of a secret bet process.

FIG. 11 is an explanatory diagram of a bet confirmation screen.

FIG. 12 is an explanatory diagram of the bet confirmation screen.

FIG. 13 is an explanatory diagram of a game management screen.

### PREFERRED EMBODIMENT OF INVENTION

(Outline of Game System)

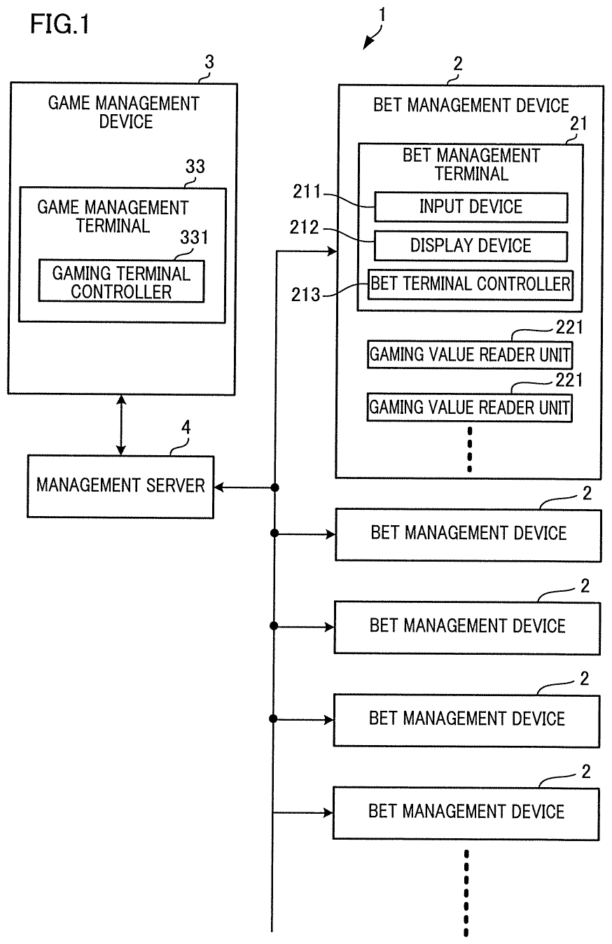

As shown in FIG. 1, a game system 1 of the present embodiment is a system allowing selection of a normal bet in which a bet is placed on a game on the premise that the content of the bet is public or a secret bet in which the content of the bet is private until a game result of the game is determined.

The word “game” includes all kinds of games in which steps from betting to payment of a payout based on an execution result can be regarded as a unit game. Therefore, the “game” may be any of a sports game, a video game, a casino game, and a board game. Examples of the “game” include baccarat, poker, mahjong, chess, and back gammon. The “game” may be any of a game based on a random number, a game based on skill and ability, a game played by a single player, and a game played by plural players. As a result, the game system 1 is able to hold a tournament in which players compete with one another based on a total gaming value amount which increases and decreases by repeatedly playing a unit game.

The game system 1 includes at least one bet management device 2 in which betting is performed by a player and a game management device 3 configured to execute a game. The bet management device 2 includes a bet management terminal 21 operated from the outside and gaming value reader units 221 capable of reading, in a non-contact manner, gaming value information of gaming media used for betting. The bet management terminal 21 includes an input device 211 which enables an input from the outside, a display device 212 which shows images to be visible from the outside, and a bet terminal controller 213. The game management device 3 includes a game management terminal 33 operated from the outside. The game management terminal 33 includes a gaming terminal controller 34.

The above-described “gaming value information” may be a coin, a banknote, electrically valuable information corresponding to these, or nonvaluable information such as a game point which does not include valuable information. The “gaming media” is tangible and has gaming value information, and examples of the “gaming media” include a chip, a medal, a token, an electronic money card, a plaque, and a ticket. The ticket is, for example, a barcoded ticket. The gaming media include exchangeable gaming media which are exchangeable into currency, and unexchangeable gaming media which are unexchangeable into currency. Each of the gaming media, i.e., a gaming medium has gaming value information in the form of electric data or appearance and is configured so that this gaming value information is readable from the outside by wireless communication, image recognition, etc. The appearance indicates information recognizable from the outside, such as color, pattern, text, image, and shape. The word “exchange” encompasses both equivalent exchange and unequal exchange.

The phrase “capable of reading gaming value information in a non-contact manner” means that gaming value information is readable from the outside by wireless communication, image recognition, etc. Examples of wireless communication include RFID (i.e., radio frequency identifier) in which information is sent and received by near-field wireless with use of an electromagnetic field, radio waves, etc.

The bet terminal controller 213 executes the following processes: a process of displaying, as the content of a bet, gaming value information of gaming media, which is read by a gaming value reader unit 221 where normal betting is performed, in association with the gaming value reader unit 221 on the display device 212; a process of allowing the input device 211 to specify a gaming value reader unit 2211 where secret betting is performed; a process of displaying, on the display device 212, secret-bet flag information in association with the gaming value reader unit 221 specified by the input device 211; a process of sending bet-progress information indicating the progress of normal betting and secret betting; and a process of determining whether the game ends based on game result information from the game management terminal 33.

The gaming terminal controller 34 executes the following process: a process of notifying the completion of preparation to start a game to the outside based on the bet-progress information sent from the bet management terminal 21, when it is determined that all bets including a normal bet and a secret bet have been placed; and a process of sending game result information indicating an execution result of the game triggered by the completion of preparation to start the game.

Because the existence of a secret bet is displayed as secret-bet flag information, the game system 1 configured as such is able to reduce the probability of occurrence of a mistake such as disclosure of the content of a secret bet in the management work.

The bet terminal controller 213 preferably executes, when determining that a game ends, a process of displaying secret-bet warning information facilitating an input of gaming value information of a secret bet on the display device 212. In this case, because secret-bet warning information is displayed and an input of gaming value information of a secret bet is facilitated, the probability of occurrence of a mistake regarding an input of the gaming value information is further reduced.

In the game system 1, data and information are preferably sent and received between the bet management device 2 and the game management device 3 via a management server 4. In this case, an additional bet management device 2 is easily provided.

The bet terminal controller 213 may execute a process of prohibiting placement of a bet on a next execution of a game, until an input of gaming value information of a secret bet is made for each gaming value reader unit 221 where secret betting is selected. This prevents an omission of an input of gaming value information of a secret bet.

The game system 1 may include a bet management device 2 configured as below. To be more specific, the bet management device 2 includes the following units: a bet table 22 having the gaming value reader units 221 capable of reading gaming value information of gaming media used for betting, in a non-contact manner; and the bet management terminal 21 having the input device 211 which enables an input from the outside, the display device 212 which shows images to be visible from the outside, and the bet terminal controller 213, and the bet terminal controller 213 executes the following processes: a process of displaying, as the content of a bet, gaming value information of gaming media, which is read by a gaming value reader unit 221 where normal betting is performed, in association with the gaming value reader unit 221 on the display device 212; a process of allowing the input device 211 to specify a gaming value reader unit 221 where secret betting is performed; and a process of displaying secret-bet flag information in association with the gaming value reader unit 221 specified by the input device 211, on the display device 212.

In the bet management device 2 configured as such, because the probability of occurrence of a mistake such as disclosure of the content of a secret bet in the management work is reduced in such a way that the existence of a secret bet is displayed as secret-bet flag information, an additional bet management device 2 is easily provided.

(Specific Example of Game System)

The following will specifically describe a case where the game system 1 executes a game of baccarat in a tournament.

In the game of baccarat in the tournament, 48 players participate in the game and play baccarat in the tournament in the order of a preliminary, a quarterfinal, a semifinal, and a final. To be more specific, out of 48 players participating in the preliminary, 36 high-score players advance to the quarterfinal, 18 players out of 36 high-score players advance to the semifinal, and 6 players finally advance to the final. Among the players who reach the final, the first-place winner, the second-place winner, and the third-place winner are determined in order of scores.

The game of baccarat is executed in five rounds in the preliminary, two rounds in the quarterfinal, and one round in each of the semifinal and the final. The game of baccarat is executed fifteen times in each round. At the final execution of the game in each round, players are allowed to select normal betting or secret betting. In the round of the final, players are allowed to select normal betting or secret betting at the final execution and any execution of the game. The following points are not particularly limited: the number of players participating in the preliminary, in the quarterfinal, in the semifinal, and in the final; how many times the secret betting is selected; when players are allowed to select the type of betting; and how many times the game of baccarat is executed in a round.

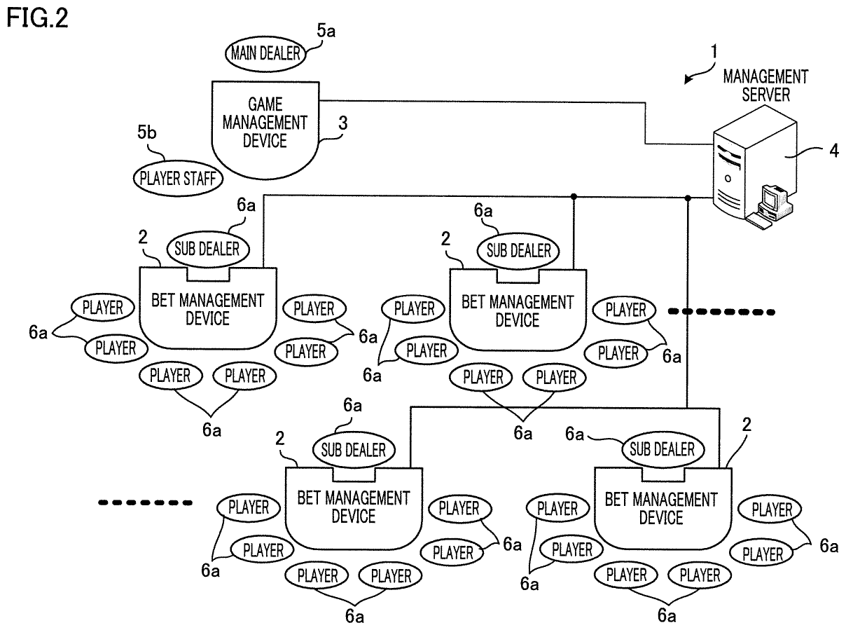

As shown in FIG. 2, the game system 1 includes bet management devices 2 in which betting is performed by players, the game management device 3 configured to execute a game of baccarat, and the management server 4 connected to the bet management devices 2 and the game management device 3 in a data communicable manner.

The bet management devices 2 are arranged so that a main dealer 5a and a player staff 5b can be placed. The main dealer 5a manages the attendance condition and bet condition of each player in all bet management devices 2, and distributes cards. The player staff 5b corresponds to a representative of players in the game of baccarat, and is a staff in the game system 1. In the round of the final, six players 6b who reach the final may show up instead of the player staff 5b, and the main dealer 5a at the game management device 3 and the players 6b can play a normal game of baccarat.

Each bet management device 2 is configured so that a sub dealer 6a and six players 6b can be placed. The sub dealer 6a manages the attendance condition and bet condition of each player 6b in the bet management device 2. In addition to that, when one player 6b selects secret betting, the sub dealer 6a keeps the content of the secret bet secret, discloses the content of the secret bet after a game result is determined, collects a chip, and awards a payout.

(Specific Example of Game System: Bet Management Device 2)

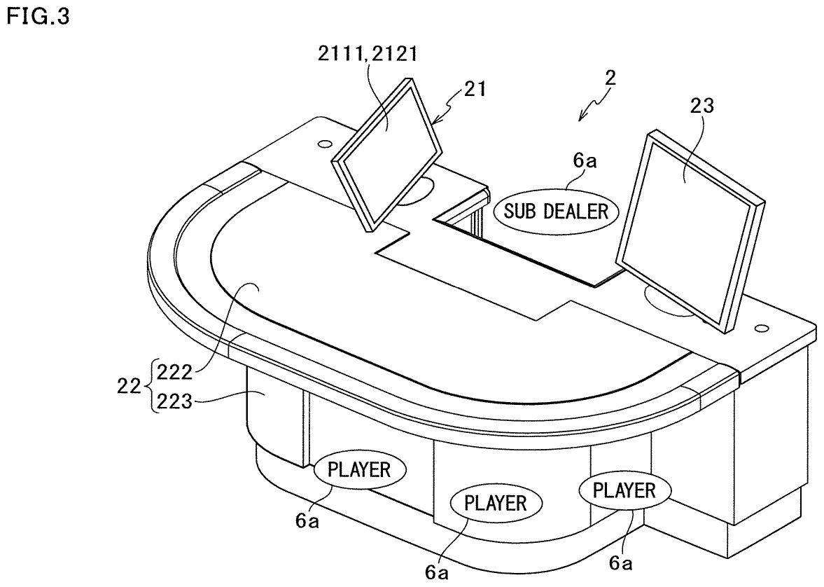

As shown in FIG. 3, each bet management device 2 includes a bet table 22 in which betting is performed by players 6b. The bet table 22 includes a table base 223 provided on the floor and a top board 222 provided on the top surface of the table base 223. The top board 222 is formed to have a substantially semi-elliptical shape. Six players 6b are placed on the arc side of the top board 222 while the sub dealer 6a is placed on the linear edge side of the top board 222.

The bet management device 2 further includes a common display 23 and the bet management terminal 21. The common display 23 is provided on one part of the linear edge side of the top board 222, and a screen of the common display 23 is visible from all players 6b. The bet management terminal 21 is provided on the other part of the linear edge side of the top board 222, and a screen of the bet management terminal 21 is provided to be visible and able to receive a touch input from the sub dealer 6a. The bet management terminal 21 may be detachably attached to the bet table 22 so that the sub dealer 6a can operate the bet management terminal 21 while carrying it. The bet management terminal 21 includes a bet management display 2121 (i.e., the display device 212 in FIG. 1) formed of a liquid crystal display, etc., and a touch panel 2111 (i.e., the input device 211 in FIG. 1) provided on the entire surface of the bet management display 2121.

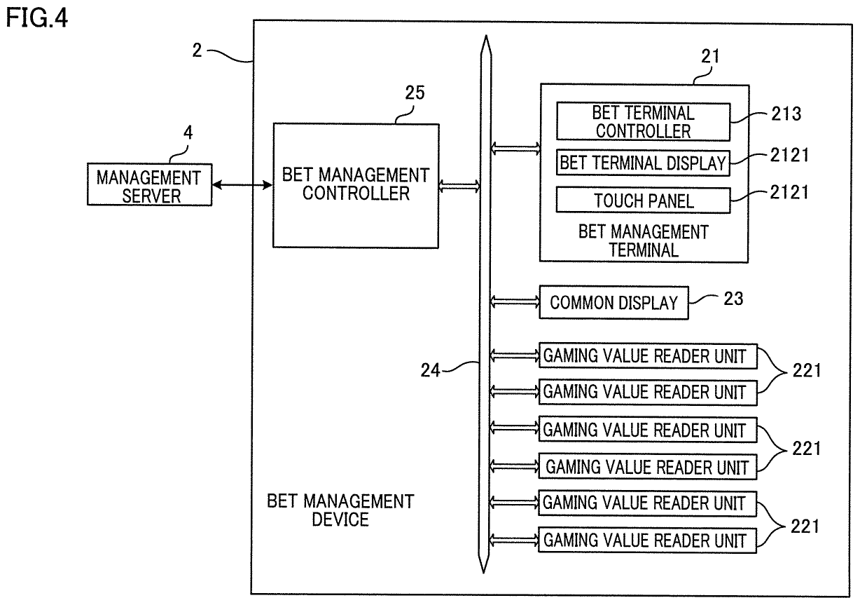

As shown in FIG. 4, the bet management display 2121 and the touch panel 2111 are controlled by the bet terminal controller 213. The bet terminal controller 213 is provided in the casing of the bet management terminal 21. The bet terminal controller 213 is connected to the common display 23, the gaming value reader units 221, and the bet management controller 25 via a signal bus 24 in a data communicable manner. The details of each gaming value reader unit 221 will be described later.

The bet management controller 25 is provided in the bet table 22 of FIG. 3. The bet management controller 25 controls the entire bet management device 2, and is able to perform data communication with the game management device 3 via the management server 4. While in the present embodiment the bet terminal controller 213 for the bet management terminal 21 is separated from the bet management controller 25 for the bet management device 2, the disclosure is not limited to this. A controller in which the bet management terminal 21 and the bet management controller 25 are integrated may be provided in the bet management terminal 21 and the bet table 22.

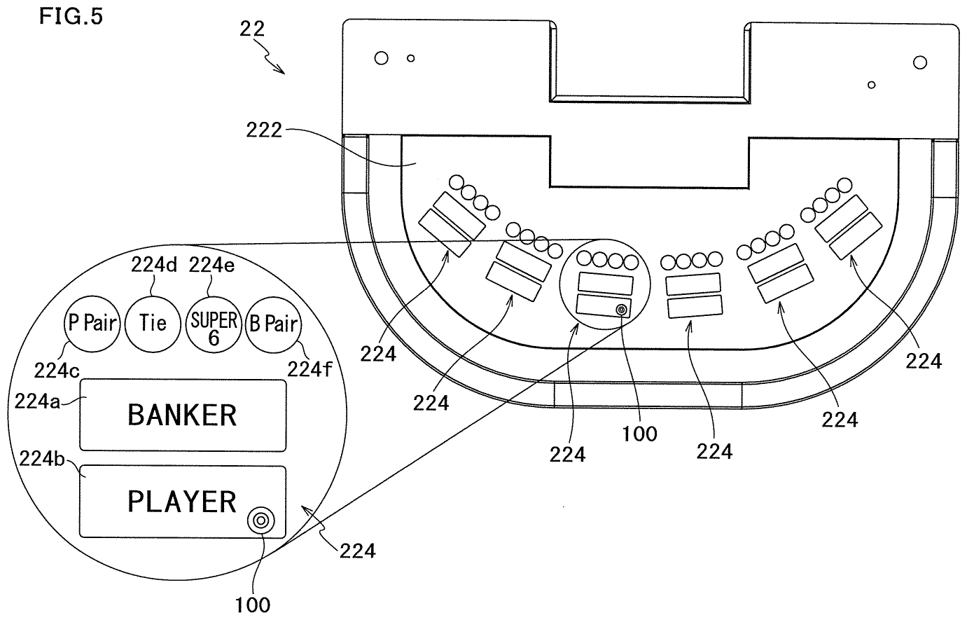

As shown in FIG. 5, betting areas 224 in which a chip 100 is placed by betting are provided on the top board 222 of the bet table 22. The number of the betting areas 224 is identical with the number of seats allowing players 6b to sit at the bet table 22. In other words, each player 6b uses one betting area 224. While the number of the betting areas 223 is six in the present embodiment, the number of the betting areas 223 may be different.

Each betting area 224 includes a banker area 224a and a player area 224b. When a player 6b places a bet on the winning of the banker side, the chip 100 corresponding to a desired bet amount is placed in the banker area 224a. Meanwhile, when a player 6b places a bet on the winning of the player side, the chip 100 corresponding to a desired bet amount is placed in the player area 224b.

Each betting area 224 further includes a player pair area 224c, a tie area 224d, a super six area 224e, and a banker pair area 224f which are used for side betting. When a player 6b places a bet on a case where the player side wins and the cards form a pair, the chip 100 corresponding to a desired bet amount is placed in the player pair area 224c. When a player 6b places a bet on a tie, the chip 100 corresponding to a desired bet amount is placed in the tie area 224d. When a player 6b places a bet on a case where the banker side wins and the lowest digit of the total number of numbers on the cards is six, the chip 100 corresponding to a desired bet amount is placed in the super six area 224e. When a player 6b places a bet on a case where the banker side wins and the cards form a pair, the chip 100 corresponding to a desired bet amount is placed in the banker pair area 224f.

(Specific Example of Game System: Bet Management Device 2: Gaming Value Reader Unit 221)

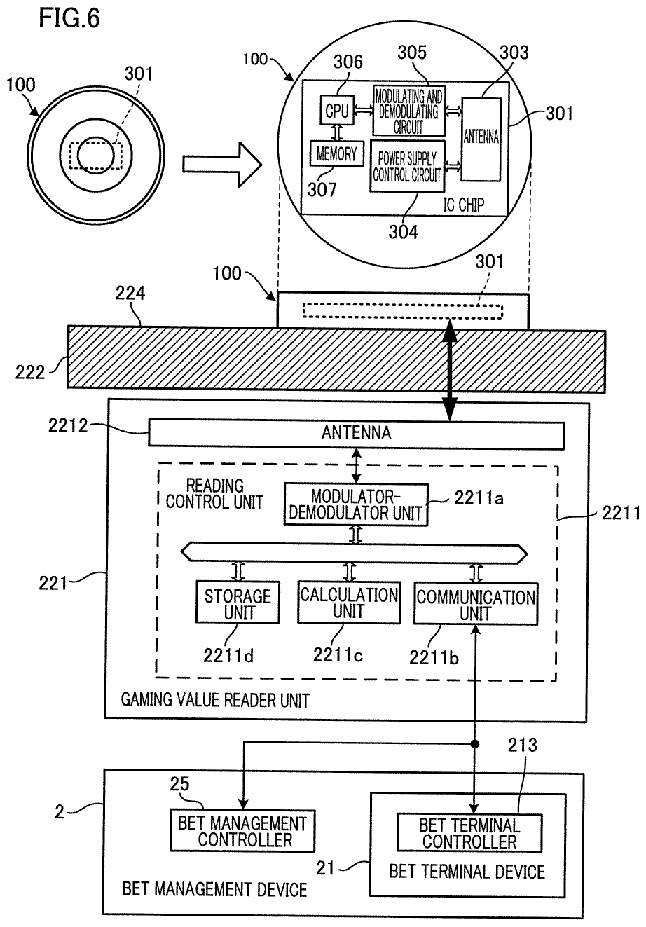

As shown in FIG. 6, the gaming value reader unit 221 is provided below each betting area 224. The gaming value reader unit 221 is able to read gaming value information, etc., of the chip 100 by wireless communication. The chip 100 is formed of resin, etc., and has therein a FRID tag which is an IC chip for RFID. To be more specific, an IC chip 301 includes a memory 307 which stores unique identification information and gaming value information, a CPU 306 which performs a controlling operation such as analyzing a received signal and sending information, a modulating and demodulating circuit 305 which modulates transmission data and demodulates received data at the same time, an antenna 303 which performs sending of the transmission data and receiving of the received data, and a power supply control circuit 304 which supplies driving power.

The gaming value reader unit 221 includes a reading control unit 2211 formed of a microcomputer, etc., and an antenna 2212. The reading control unit 2211 includes a modulator-demodulator unit 2211a, a communication unit 2211b, a calculation unit 2211c, and a storage unit 2211d. The modulator-demodulator unit 2211a is connected to the antenna 2212. The modulator-demodulator unit 2211a has a modulation function in which the format of data is converted into a signal format suitable for data communication via the antenna 2212 from a signal format suitable for information processing and a demodulation function in which the format of data is converted into the signal format suitable for information processing from the signal format suitable for data communication.

The communication unit 2211b is connected to the bet terminal controller 213 and the bet management controller 25, and is able to send gaming value information of the chip 100 to each of the controllers 213 and 25. The storage unit 2211d stores programs causing the calculation unit 2211c to execute a process of reading gaming value information of the chip 100, a process of sending the information, a process of determining genuineness based on identification information, a process of sending this determination result, etc.

(Specific Example of Game System: Game Management Device 3)

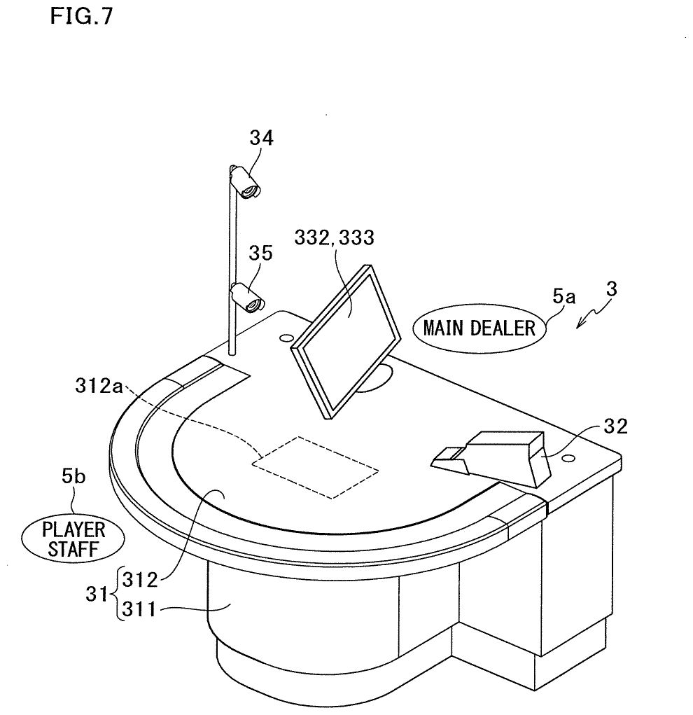

As shown in FIG. 7, the game management device 3 includes a gaming table 31 at which baccarat is played. The gaming table 31 includes a table base 311 provided on the floor and a top board 312 provided on the top surface of the table base 311. The top board 312 is formed to have a substantially semicircular shape, and is provided with a card arrangement area 312a on the top surface of the central portion and six betting areas on the top surface on the arc side. Each betting area is identical to the betting area 224 in FIG. 5.

The player staff 5b is placed on the arc side of the top board 312 while the main dealer 5a is placed on the linear edge side of the top board 312. In the round of the final, six players who reach the final may show up instead of the player staff 5b, and a game of baccarat is actually executable by the players.

The game management device 3 further includes a card shoe 32, a first camera device 34, and a second camera device 35. The card shoe 32 is arranged so that cards can be serially taken out therefrom, and the main dealer 5a advances a game by taking out a card from the card shoe 32. The card taken out from the card shoe 32 is placed in the card arrangement area 312a.

The card shoe 32 includes a scanner. When the main dealer 5a takes out cards from the card shoe 32, an image on each card is read by the scanner. The card shoe 32 executes a process such as image recognition regarding image information read from the card by the scanner, so as to specify the details of the card such as the number, the mark indicating the type of the card, and the picture.

The first camera device 34 is provided at a position where an image of the entire gaming table 31 and the player staff 5b can be captured. Meanwhile, the second camera device 35 is provided at a position where an image of the card arrangement area 312a and a card placed by the main dealer 5a can be captured.

The game management device 3 further includes the game management terminal 33. The game management terminal 33 is provided on the linear edge side of the top board 312, and a screen of the game management terminal 33 is provided to be visible and able to receive a touch input from the main dealer 5a. The game management terminal 33 may be detachably attached to the gaming table 31 so that the main dealer 5a can operate the game management terminal 33 while carrying it.

The game management terminal 33 includes a game management display 332 formed of a liquid crystal display, etc., and a touch panel 333 provided on the entire surface of the game management display 332.

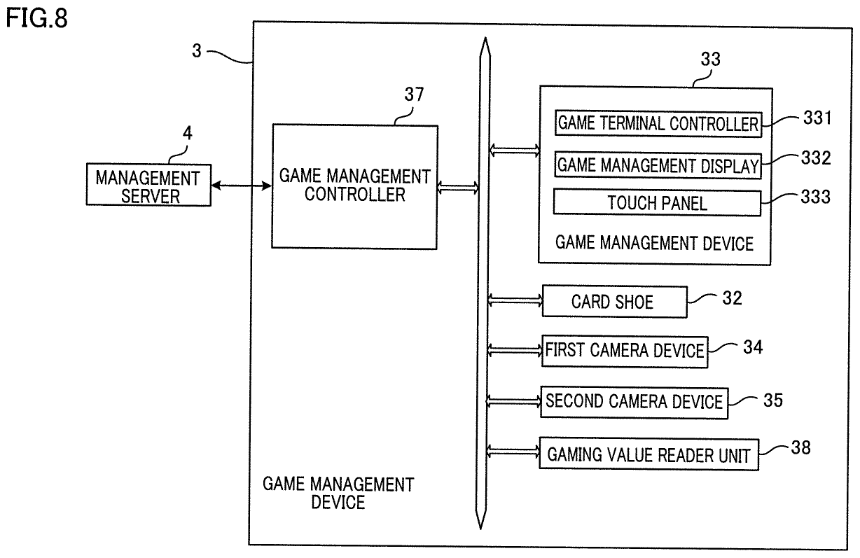

As shown in FIG. 8, the game management display 332 and the touch panel 333 are controlled by a gaming terminal controller 331. The gaming terminal controller 331 is provided in the casing of the game management terminal 33. The gaming terminal controller 331 is connected to the card shoe 32, the first camera device 34, the second camera device 35 via a signal bus 36 in a data communicable manner, and allows various types of information such as image information and moving-image information which are obtained by these devices 32, 34, and 35 to be displayable on the game management display 332. In addition to that, the gaming terminal controller 331 is connected to a game management controller 37 in a data communicable manner. The game management device 3 further includes six gaming value reader units 38 provided to correspond to the betting areas 224. Each gaming value reader unit 38 is identical with the gaming value reader unit 221 of FIG. 6.

The game management device 37 is provided in the gaming table 31 of FIG. 7. The game management device 37 controls the entire game management device 3, and is able to perform data communication with all bet management devices 2 via the management server 4. While in the present embodiment the gaming terminal controller 331 for the game management terminal 33 is separated from the game management controller 37 for the game management device 3, the disclosure is not limited to this. A controller in which the gaming terminal controller 331 and the game management controller 37 are integrated may be provided in the game management terminal 33 and the gaming table 31.

(Specific Example of Game System: Operation)

The following will describe operation steps of the bet management devices 2 and the game management device 3 in a case where a game of baccarat is executed in a round of the preliminary, in the game system 1 configured as described above. In this regard, the following describes a case where all data communication between the bet management devices 2 and the game management device 3 is performed via the management server 4. However, a part of or all data communication may be directly performed without the intermediary of the management server 4.

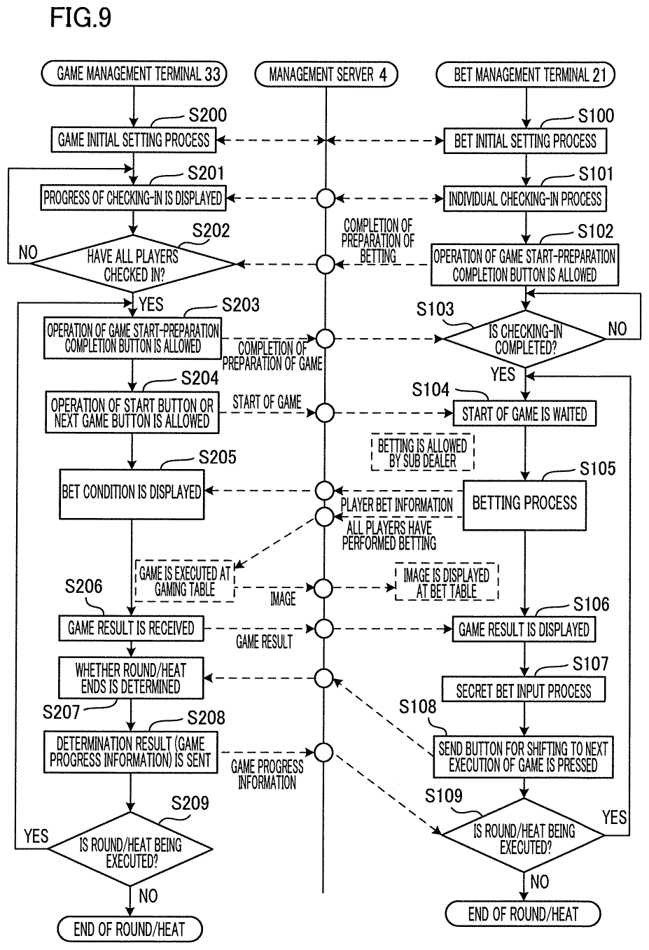

As shown in FIG. 9, before a tournament begins, a game initial setting process is executed in bet management devices 2 and the game management device 3 (S100, S200). To be more specific, the main dealer 5a is placed at the gaming table 31, and a sub dealer 6a is placed at each bet table 22. In addition to that, the main dealer 5a enters his/her ID and password on the touch panel 333 of the game management terminal 33, and logs in the management server 4. Each sub dealer 6a also enters his/her ID and password on the touch panel 2111 of the bet management terminal 21, and logs in the management server 4.

After the process above is executed, an individual checking-in process is executed for each player 6b in each bet management terminal 21 (S101). To be more specific, the reception of entry based on, e.g., a participant ID of a player 6b starts, and the sub dealer 6a makes an operation and performs the work of determining that the player 6b sitting at a seat number of the bet table 22 is a genuine participant. This determination work is performed for each player 6b. At this time, the progress of the individual checking-in process is displayed on the game management terminal 33 so that the main dealer 5a can check the progress of this process (S201).

When the individual checking-in process has been executed for all players 6b in each bet management terminal 21, an operation of a game start-preparation completion button is allowed (S102). In this regard, when the sub dealer 6a operates the game start-preparation completion button, a bet preparation completion signal is sent to the game management terminal 33. After that, a standby state is maintained until a game preparation completion signal is supplied from the game management terminal 33 (S103).

In the game management terminal 33, when the bet preparation completion signal is supplied, the completion state of checking-in in a bet management terminal 21 which is the sender of the signal is displayed. When the bet preparation completion signal is supplied from each of all bet management terminals 21 and the completion states of checking-in in the bet management terminals 21 are displayed (YES in S202), an operation of a game preparation completion button is allowed (S203). In this regard, when the main dealer 5a operates the game start-preparation completion button, the game preparation completion signal is sent to the bet management terminals 21. After that, an operation of a game button or a next game button is allowed (S204). In this regard, when the main dealer 5a operates the button, a game start signal is sent to the bet management terminals 21.

In each bet management terminal 21, when the game preparation completion signal is supplied, it is determined that all players 6b participating in the current round have been checked in (YES in S103), and the start of the game is waited for. Then, when the game start signal from the game management terminal 33 is supplied, the shift to a betting process occurs (S105). At this time, the sub dealer 6a is notified that the game is executable, the sub dealer 6a permits players 6b to place a bet, and the players 6b starts betting. In the betting process, player bet information indicating the content of a normal bet of each player 6b is sent to the game management terminal 33, and an all-players bet completion signal indicating that all players 6b complete betting is sent to the game management terminal 33.

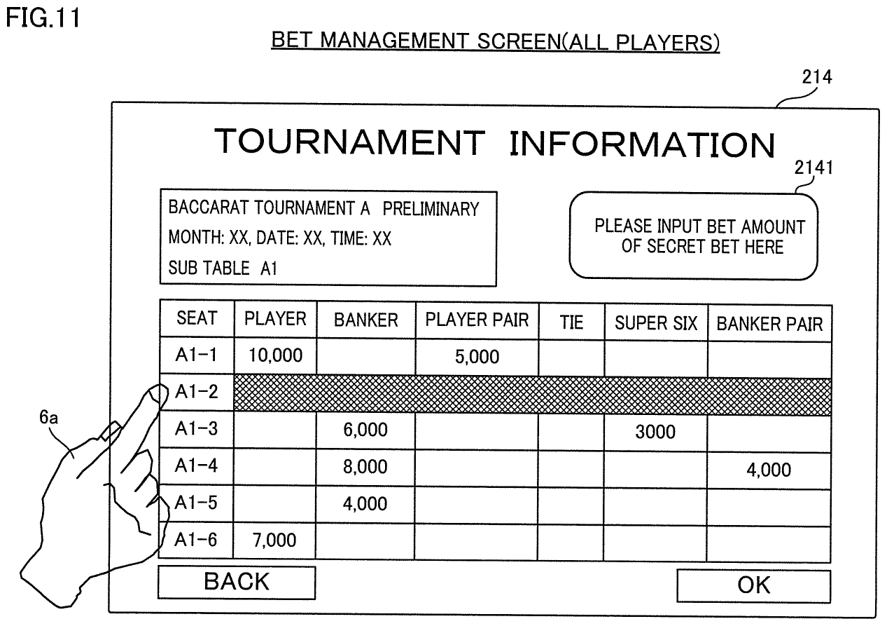

To be more specific, when the betting process starts, a bet confirmation screen 214 indicating seat numbers (e.g., A1-1 to A1-6), the type of a bet (e.g., “player”, “banker”, “player pair”, “tie”, “super six”, and “banker pair”), and the bet amount which correspond to each seat number is displayed as shown in FIG. 11. After that, an input of bet information is received. Because of this, for example, when a player 6b sitting at the seat number “A1-1” performs normal betting on the “player” by use of a chip 100 corresponding to a bet amount of 10000 and performs normal betting on the “player pair” by use of a chip 100 corresponding to a bet amount of 5000, gaming value information of each chip 100 is read by the gaming value reader unit 221 so that 10000 and 5000 are respectively displayed in areas of types of bets (i.e., areas of “player” and “player pair”) on the bet confirmation screen 214 corresponding to the seat number “A1-1”. As a result, a sub dealer 6a can easily check the bet condition by comparing the chips 100 used for normal betting by the player 6b with the displayed contents on the bet confirmation screen 214.

For another example, when a player 6b sitting at the seat number “A1-2” writes a bet amount on a piece of paper and hands the piece of paper to a sub dealer 6a, the type of this bet is secret betting. In this case, the sub dealer 6a makes a touch input at the seat number “A1-2” of the player 6b on the bet confirmation screen 214 and registers information indicating that the player 6b of the seat number “A1-1” has placed a secret bet, in the bet management terminal 21. The bet management terminal 21 then informs the sub dealer 6a about the existence of a secret bet until a game result is determined, in such a way that the color of the display area of the bet amount corresponding to the seat number “A1-2” of the player 6b is changed into gray, etc., on the bet confirmation screen 214.

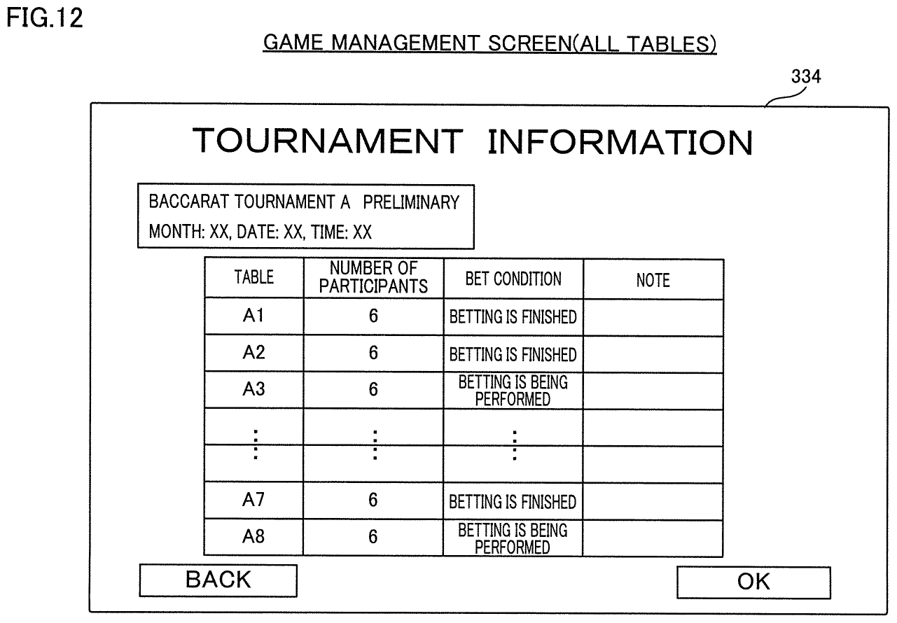

In the game management terminal 33, the bet condition can be checked for each player 6b based on the player bet information and for each bet management device 2 based on the all-players bet completion signal (S205). For example, as shown in FIG. 12, the game management terminal 33 displays a game management screen 334 in which identification numbers (e.g., A1 to A8) of tables indicating the bet management devices 2, the number of participating players 6b in each bet management device 2, and the bet condition in each bet management device 2 can be checked. In this case, the main dealer 5a can confirm that all players in the bet management devices 2 of A1, A2, and A7 complete betting whereas betting is being performed in the bet management devices 2 of A3 and A8.

When betting is completed in all bet management devices 2, cards are distributed and a game of baccarat is executed. The progress of this game is filmed by the first camera device 34 and the second camera device 35, and is displayed on the common display 23 by sending image information to each bet management device 2. This allows each player 6b to visually check the progress of the game.

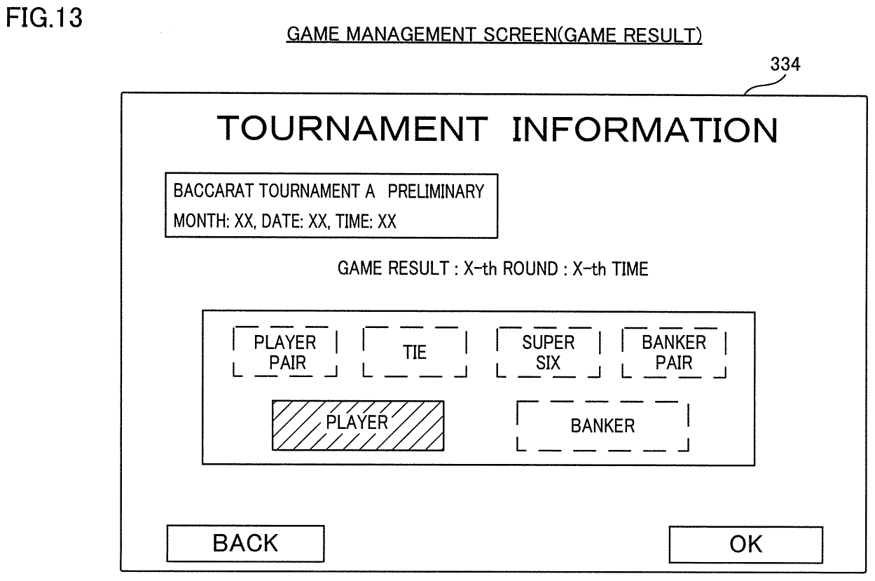

When the game is finished, a game management screen of game result information is displayed on the game management terminal 33 based on information from the card shoe 32 which reads the cards. For example, the game management screen of FIG. 13 indicates that the display area “player”, in which an area inside a solid line of an outer frame is painted in color, is a winner. The main dealer 5a confirms the result of the game by making a touch input at an OK button in a case where there is no error in the displayed game result (S206). As a result, the game result information is sent to the bet management terminal 21.

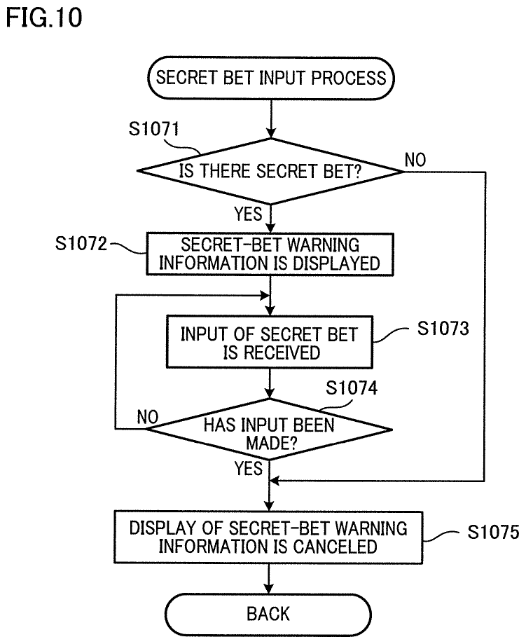

In the bet management terminal 21, the game result information is displayed on the bet management terminal 21 and the common display 23 (S106). Subsequently, a secret bet input process (S107) is executed. To be more specific, as shown in FIG. 10, whether secret betting has been performed is determined (S1071). When secret betting is not performed (NO in S1071), this process ends. Meanwhile, when secret betting has been performed (YES in S1071), secret-bet warning information is displayed on the bet confirmation screen 214 (S1072). To be more specific, a warning display area 2141 appears on the bet confirmation screen of FIG. 11, and the secret-bet warning information is displayed to notify the sub dealer 6a that secret betting has been performed.

After that, the sub dealer 6a receives an input of the content of a secret bet (e.g., the type of a bet and the bet amount; S1073). When the input of the content of a secret bet has been made (YES in S1074) and the display of the secret-bet warning information is canceled (S1075), this process ends.

Subsequently, the sub dealer 6a collects chips 100 and performs payment. After that, when a sending button for shifting to the next execution of the game is pressed (S108), whether a round/heat is being executed is determined based on game progress information from the game management terminal 33 (S109). When the round/heat is being executed (YES in S109), steps from the step S104 are executed again and the standby state is maintained until the start of the game. Meanwhile, when the round/heat is not being executed (NO in S109), this process ends.

In the game management terminal 33, when a shifting button is pressed in each game management terminal 33, whether the round/heat ends is determined (S207). Subsequently, after a determination result is sent to each bet management terminal 21 as the game progress information (S208), steps from the step 5203 are executed again when the round/heat is being executed (YES in S209), or the process ends when the round/heat is not being executed (NO in S209).

Embodiments of the present invention thus described above solely serve as specific examples of the present invention, and are not to limit the scope of the present invention. The specific structures and the like are suitably modifiable. Further, the effects described in the embodiments of the present invention described in the above embodiment are no more than examples of preferable effects brought about by the present invention, and the effects of the present invention are not limited to those described hereinabove.

### REFERENCE SIGNS LIST

1 game system
2 bet management device
21 bet management terminal
211 input device
212 display device
213 bet terminal controller
214 bet confirmation screen
22 bet table
211 gaming value reader unit
224 betting area
23 common display
24 signal bus
25 bet management controller
3 game management device
31 gaming table
32 card shoe
32 main dealer display
33 game management terminal
34 first camera device
35 second camera device
4 management server 4
5a main dealer
5b player staff
6a sub dealer
6b player

What is claimed is:

1. A game system allowing selection of normal betting in which at least one bet is placed on a game and a content of the at least one bet is public or secret betting in which the content of the at least one bet is private until a game result of the game is determined, the game system comprising:
a game management device which includes a game management terminal operated from the outside and which executes the game; and
at least one bet management device which includes a bet management terminal operated from the outside and gaming value reader units capable of reading, in a non-contact manner, gaming value information of a gaming medium used for the at least one bet,
the at least one bet management terminal including:
an input device which enables an input from the outside;
a display device which shows an image to be visible from the outside; and
a bet terminal controller programmed to execute: a process of displaying, on the display device, as the content of the at least one bet, the gaming value information of the gaming medium which is read by one of the gaming value reader units in which the normal betting is performed, in association with the one of the gaming value reader units;
a process of allowing the input device to specify one of the gaming value reader units in which the secret betting is performed;
a process of displaying secret-bet flag information on the display device, in association with the one of the gaming value reader units which is specified by the input device;
a process of sending bet-progress information indicating that the progress of the normal betting and the secret betting; and
a process of determining whether the game ends based on game result information from the game management terminal, and
the game management terminal including a gaming terminal controller programmed to execute:
a process of notifying the completion of preparation to start the game to the outside, in a case where it is determined based on the bet-progress information which is sent from the at least one bet management terminal that all bets including the normal betting and the secret betting are completed; and
a process of sending the game result information indicating an execution result of the game triggered by the completion of the preparation to start the game.

2. The game system according to claim 1, wherein, the bet terminal controller is programmed to further execute a process of displaying secret-bet warning information facilitating an input of the gaming value information of the secret betting on the display device when it is determined that the game ends.

3. The game system according to claim 2, wherein, the bet terminal controller is programmed to further execute a process of prohibiting placement of at least one bet on the next execution of the game, until the input of the gaming value information of the secret betting is made for all of the gaming value reader units.

4. A bet management device of a game system allowing selection of normal betting in which at least one bet is placed and a content of the at least one bet is public or secret betting in which the content of the at least one bet is private until a game result of the game is determined, the bet management device comprising:
a bet table including gaming value reader units capable of reading, in a non-contact manner, gaming value information of a gaming medium used for the at least one bet; and
a bet management terminal including an input device which enables an input from the outside, a display device which shows an image to be visible from the outside, and a bet terminal controller,
the bet terminal controller is programmed to execute:
a process of displaying, on the display device, as the content of the at least one bet, the gaming value information of the gaming medium which is read by one of the gaming value reader units in which the normal betting is performed, in association with the one of the gaming value reader units;
a process of allowing the input device to specify one of the gaming value reader units in which the secret betting is performed; and
a process of displaying secret-bet flag information on the display device, in association with the one of the gaming value reader units which is specified by the input device.
